(19) United States
(12) Patent Application Publication
(10) Pub. No.: US 2026/0007102 A1
(43) Pub. Date: Jan. 8, 2026

(54) SELF-PROPELLED FORAGE HARVESTER

(71) Applicant: CLAAS Selbstfahrende Erntemaschinen GmbH, Harsewinkel (DE)

(72) Inventors: Niklas Löffler, Hohentengen (DE); Tobias Deufel, Meßkirch-Menningen (DE)

(73) Assignee: CLAAS Selbstfahrende Erntemaschinen GmbH, Harsewinkel (DE)

(21) Appl. No.: 19/259,421

(22) Filed: Jul. 3, 2025

(30) Foreign Application Priority Data
Jul. 3, 2024 (DE) 10 2024 118 901.0

(51) Int. Cl. A01D 43/08

(52) U.S. Cl. CPC A01D 43/085

(57) ABSTRACT

A self-propelled forage harvester. The self-propelled forage harvester includes a chopping device, a post-acceleration device, and a harvested material conveyor chute, which is arranged or positioned between the chopping device and the post-acceleration device. The harvested material conveyor chute includes an adjustable inner cross-section.

### CROSS REFERENCE TO RELATED APPLICATION

This application claims priority under 35 U.S.C. § 119 to German Patent Application No. DE 10 2024 118 901.0 filed Jul. 3, 2024, the entire disclosure of which is hereby incorporated by reference herein.

### TECHNICAL FIELD

The present invention relates to a self-propelled forage harvester and a method for controlling a self-propelled forage harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

DE 10 2016 215 045 A1 discloses a self-propelled forage harvester with at least one chopping device and a post-acceleration device arranged or positioned downstream (in terms of processing) of the chopping device. The chopping device comminutes the harvested material that is collected by a front attachment of the forage harvester, and then fed to a post-acceleration device through a harvested material conveyor chute. The post-acceleration device is configured to accelerate the chopped harvested material. A transfer device, for ejecting the harvested material into a loading container, is downstream from the post-acceleration device.

DE 10 2016 215 045 A1 discloses a variably designed inner cross-section of the transfer device downstream from the post-acceleration device in order to avoid turbulence or fanning of the material flow within the transfer device.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates an exemplary schematic side view of a self-propelled forage harvester.

FIG. 2 illustrates a schematic representation of a conveyor chute of the forage harvester according to FIG. 1 with a grass chute.

FIG. 3 illustrates an exemplary schematic representation of a harvested material conveyor chute designed as a grass chute.

FIG. 4 illustrates an exemplary schematic representation of a self-propelled forage harvester with a swath detection device.

### DETAILED DESCRIPTION

As discussed in the background, DE 10 2016 215 045 A1 discloses a variably designed inner cross-section of the transfer device downstream from the post-acceleration device in order to avoid turbulence or fanning of the material flow within the transfer device, and therefore a reduced material flow quality. Despite the variable inner cross-section, the material flow quality within the transfer device may decrease in certain harvesting situations since the post-acceleration device cannot optimally process or accept and accelerate a harvested material flow fed thereto.

Thus, to avoid the one or more disadvantages, a self-propelled forage harvester is disclosed which may improve processing, such as improved collecting and acceleration, of a harvested material flow fed to a post-acceleration device.

In one or some embodiments, a self-propelled forage harvester is disclosed with a chopping device, a post-acceleration device, and a harvested material conveyor chute, which may be arranged or positioned between the chopping device and the post-acceleration device. Further, the harvested material conveyor chute may have an adjustable inner cross-section.

The material cushion height or thickness of a harvested material flow, with which the post-acceleration device is fed, may influence the material flow quality and/or ejection quality of the post-acceleration device, and therefore on the material flow quality of the harvested material flow to be ejected onto a transfer vehicle using a transfer device downstream from the post-acceleration device. In this regard, a thick harvested material mat may be processed better by the post-acceleration device than a thin harvested material mat. With a thicker harvested material mat fed to the post-acceleration device, a harvested material stream emerging from the post-acceleration device may be more stable or have a lower tendency to fan out or swirl. Consequently, the disclosed harvested material conveyor chute, which is configured to adjust to different inner cross-sections, may make enable reduction of the inner cross-section at low harvested material throughputs in such a way that the harvested material mat is compressed, and therefore the thickness of the harvested material mat may be increased. Accordingly, the material flow quality of the harvested material flow to be ejected onto a transfer vehicle may be improved by the variable cross-section of the harvested material conveyor chute, even at low harvested material throughputs.

Various one or more parts of the harvested material conveyor chute may adjust. In one or some embodiments, the harvested material conveyor chute may have at least one wall element with a variable position for adjusting the inner cross-section. Such a wall element may make it possible to create an adjustable inner cross-section in an uncomplicated manner. The wall element may be moved in one or more ways. For example, to change the inner cross-section, the wall element may be pivoted into or out of an inner space of the harvested material conveyor chute.

In one or some embodiments, the harvested material conveyor chute comprises a front wall, a rear wall and two mutually opposing side walls connecting the front wall and rear wall to one another. The position-adjustable wall element may be arranged or positioned on one of the side walls. The arrangement of the wall element on one of the side walls may make it possible to compress a harvested material flow guided past the wall element in such a way that the thickness of the harvested material mat increases.

In one or some embodiments, a position-adjustable wall element may be arranged or positioned on each of the two side walls. Consequently, both wall elements may be pivoted into the inner space in the same way to compress a harvested material flow so that a compressed harvested material flow is guided through the center of the harvested material conveyor chute.

For the flow behavior of the harvested material flow, it may be particularly advantageous for the wall element to extend from an end of the harvested material conveyor chute facing the chopping device to an end of the harvested material conveyor chute facing the post-acceleration device.

In one or some embodiments, the wall element may be arranged or positioned pivotably on the harvested material conveyor chute using a joint, such as a hinge, wherein the joint may be arranged or positioned at the end of the harvested material conveyor chute facing the chopping device.

In one or some embodiments, the forage harvester may comprise an actuator configured to adjust the position of the wall element(s). As such, in one or some embodiments, the movement may be automatically performed with no manual adjustment of the wall element(s) required so that a change in the harvested material throughput may be achieved by an adjustment of the position of the wall element(s). For example, the automatic movement may be triggered automatically (without operator input) or by operator input from a user interface, such as a touchscreen in the driver's cab of the forage harvester (responsive to the operator input, a control device of the forage harvester may automatically control the actuator(s) to automatically adjust the position of the wall element(s)).

In this regard, in one or some embodiments, the forage harvester may comprise a control device configured to automatically control and/or automatically regulate the actuator. In this regard, the control device may be configured in such a way that the control device automatically adjusts the position of the wall elements to a harvesting situation (e.g., responsive to detecting a particular harvesting situation).

Furthermore, in one or some embodiments, the control device is configured to automatically actuate the actuator depending on at least one aspect of harvested material, such as depending on a harvested material throughput. In particular, the control device may automatically control the actuator in such a way that the wall element is in a position that is pivoted further into the inner space given a low harvested material throughput than given a high harvested material throughput. In the regard, the control device may be configured to automatically analyze one or more aspects of the harvested material, such as one or more aspects of the harvested material flow (e.g., the harvested material flow throughput). For example, the control device may automatically analyze the harvested material flow throughput, and responsive to the analysis, automatically control the actuator(s) accordingly. In one particular example, the control device may automatically compare the determined harvested material flow throughput with one or more predetermined throughputs. Responsive to the automatic comparison (e.g., the harvested material flow throughput is less than the predetermined throughput indicating low throughput or greater than determining the predetermined throughput indicating high throughput), the control device may automatically control the actuator(s) accordingly. In this regard, responsive to automatically determining whether the harvested material flow throughput is low or is high, the control device may automatically control the actuator (and in turn the wall element(s)) accordingly. Consequently, the harvested material mat may be automatically compressed given a lower harvested material throughput in order to achieve an improved harvested material flow quality.

In one or some embodiments, the control device may automatically determine the harvested material throughput in one or more ways using one or more sensors (e.g., at least one sensor, at least one sensor array). In one or some embodiments, the control device may be configured to automatically receive and automatically evaluate data generated by a swath detection device arranged or positioned on the forage harvester, with the control device automatically determining the harvested material throughput depending on an automatic evaluation of the data from the swath detection device. In turn, responsive to automatically determining the harvested material throughput, the control device may automatically control actuation of the actuators.

In one or some embodiments, the swath detection device comprises at least one optical sensor configured to determine or generate data indicative of data relating to the shape of a swath to be collected by the forage harvester. In this way, the harvested material throughput may be determined particularly early, and the position of the wall elements may be adapted or adjusted for an imminent change in the harvested material throughput.

In addition or alternatively, the swath detection device may be designed with at least one sensor assembly which is configured to generate data indicative of or detecting a layer height in an intake unit of the forage harvester. The swath detection device may transmit the data determined or generated by the at least one sensor assembly to the control device. In turn, the control device may automatically analyze the data transmitted by the swath detection device in order to determine the harvested material throughput.

In one or some embodiments, viewed in the material flow direction of a harvested material flow, a feed channel may be arranged or positioned downstream from the chopping device, and the harvested material conveyor chute may be designed as a grass chute which adjoins the feed channel downstream. The grass chute may be arranged or positioned interchangeably on the feed channel. In particular, the grass chute may be arranged or positioned directly upstream from the post-acceleration device so that the thickness of a harvested material mat to be fed to the post-acceleration device may be adjusted in a very advantageous manner.

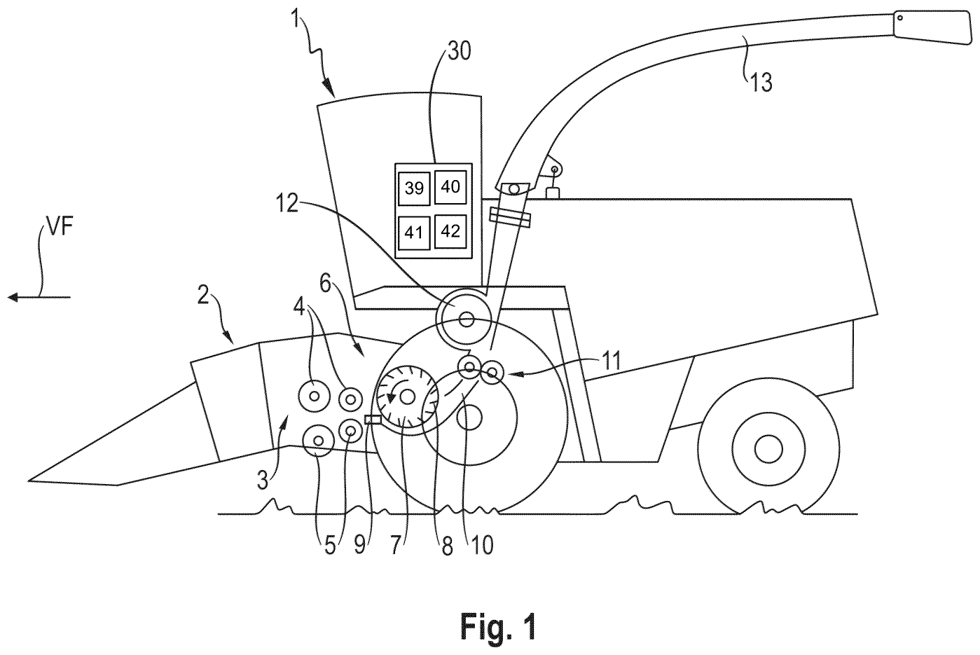

Referring to the figures, FIG. 1 shows an exemplary schematic side view of a self-propelled forage harvester 1 in a side view. Examples of forage harvesters are disclosed in US Patent Application Publication No. 2024/0196796 A1, US Patent Application Publication No. 2024/0237580 A1, US Patent Application Publication No. 2025/0072326 A1, each of which are incorporated by reference herein in their entirety. Forage harvester 1 has a front attachment 2 arranged or positioned in the front area for picking up or collecting harvested material located on the ground. The front attachment 2 may vary depending on the type of harvested material to be harvested or picked up. The attachment 2 may collect the harvested material from the field and convey the harvested material to an intake unit 3, which in the illustrated embodiment comprises (or consists of) a roller group with upper and lower feed rollers 4, 5. The feed rollers 4, 5 of the intake unit 3 may exert a pressing force on the picked up harvested material. The intake unit 3 may convey the harvested material compacted into a harvested material mat to a chopping device 6, which has a rotatingly driven cutterhead 7 with chopping blades 8 distributed around its circumference. The chopping blades 8 may cut the harvested material mat fed by the intake unit 3 against a shear bar 9. The cut or chopped harvested material may be conveyed by the rotary movement of the cutterhead 7 into a downstream feed channel 10, from where, depending on the equipment of the forage harvester 1, the harvested material may be processed by an optional post-processing device 11, also known as a conditioning device or corncracker, arranged or positioned in the crop flow path, and may be conveyed by a downstream, rotationally driven post-acceleration device 12, additionally accelerated by an adjustable transfer device 13, into an accompanying transport vehicle. The optional post-processing device 11 may either be swung out of the harvested material flow path or removed completely. The transfer device 13 may be rotated about a vertical axis, for example using a slewing ring. In addition and independently of this, the transfer device 13 may be pivoted about a horizontal axis. A so-called ejection flap may be arranged or positioned at the free end of the transfer device 13, which may be pivoted about a horizontal axis relative to the transfer device 13.

The post-processing device 11 may be used during maize harvesting and may serve to process the maize kernels. When harvesting grass, however, the post-processing device 11 need not be used. Instead of the post-processing device 11, a grass chute 16 designed as a harvested material conveyor shaft 24 may be positioned downstream from the feed channel 10.

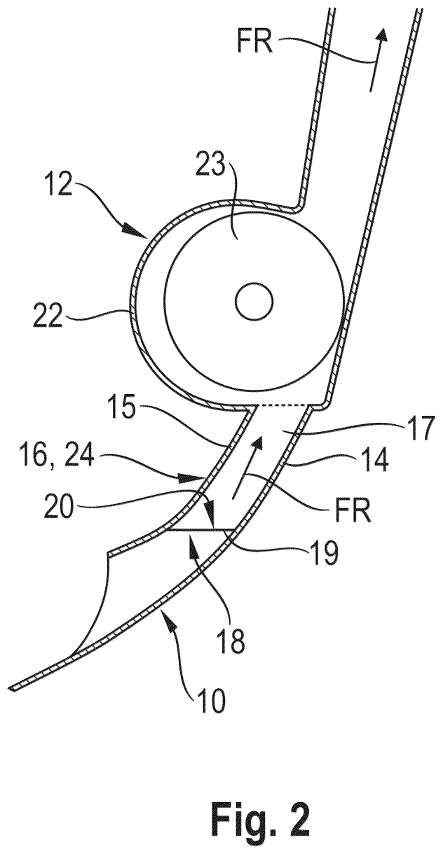

FIG. 2 illustrates an exemplary schematic representation of the feed channel 10 with a grass chute 16 arranged or positioned on the feed channel 10. The chopping device 6 and the post-acceleration device 12 may form working units of the forage harvester 1, which may be arranged or positioned one behind the other in ascending order as seen in the material flow direction FR of a harvested material flow of the picked up and chopped harvested material, and may be connected to each other by the feed channel 10 and the grass chute 16. For reasons of simplification, the cutter head 7 is not shown in FIG. 2. The post-acceleration device 12 may comprise a rotating conveyor rotor 23 arranged or positioned in a housing 22. The feed channel 10 may form a channel section directly connected to the chopping device 6, wherein the grass chute 16 is an extension of the feed channel 10 towards the post-acceleration device 12. An inlet area 20 of the grass cute 16 may be connected to an outlet area 18 of the feed channel 10 in a connection area 19.

The grass chute 16 may be bounded by a rear wall 14 and a front wall 15. The rear wall 14 and the front wall 15 may be connected to each other by side walls 17 arranged or positioned substantially perpendicular to them so that the grass chute 16 is closed in the circumferential direction. The front wall 15 and the rear wall 14 may extend substantially in the axial direction of the conveyor rotor 23. The side walls 17 may extend substantially in the forward travel direction VF of the forage harvester 1.

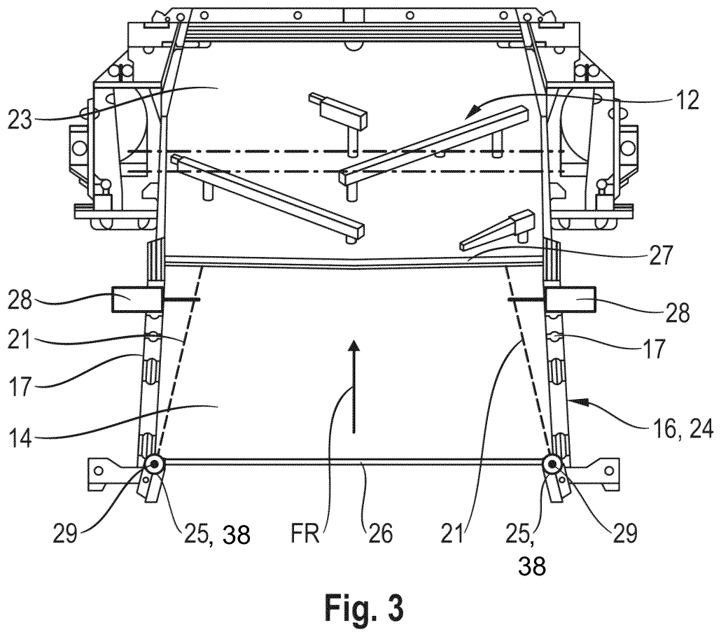

The grass chute 16 or harvested material conveyor chute 24 and the post-acceleration device 12 arranged or positioned downstream from the grass chute 16 are shown schematically in a perspective top view in FIG. 3. A position-adjustable wall element 21 for adjusting the inner cross-section of the grass chute 16 may be arranged or positioned on each of the side walls 17 of the grass chute 16. In an alternative embodiment, a position-adjustable wall element 21 may also be arranged or positioned on only one of the side walls 17. The given wall element 21 may extend from an end 26 of the grass chute 16 facing the chopping device 6 to an end 27 of the grass chute 16 facing the post-acceleration device 12, so that the given wall element 21 may extend substantially over the entire length of the grass chute 16 viewed in the harvested material flow direction FR. In this case, the given wall element 21 also may extend substantially over the entire width of the given side wall 17 so that it substantially covers the entire surface of the given side wall 17. The given wall element 21 may be arranged or positioned to pivot on the given side wall 17 using a joint 38, that may be designed as a hinge 25. Other types of joints 38 are contemplated, such as ball and socket, pivot, saddle, condyloid, or gliding joints. In the depicted example, the hinge 25 is located at the end 26 of the grass chute 16 facing the chopping device 6. Consequently, the inner cross-section may be increasingly tapered by the wall element 21 in a position of the wall element 21 pivoted into the interior of the grass chute 16 viewed in the harvested material flow direction FR.

The given wall element 21 may be assigned an actuator 28 for pivoting, such as continuously pivoting, of the given wall element 21 about a pivot axis 29 defined by the respective hinge 25. The actuators 28 may be designed as electrically or hydraulically actuatable actuating elements. Other types of actuators 28 are contemplated. In addition, the forage harvester 1 comprises a control device 30 which is configured to control and/or regulate the actuators 28.

In one or some embodiments, the control device 30 may comprise at least one processor 39, at least one memory 40 (configured to store data, such as sensor data, predetermined thresholds, and/or computer-executable instructions stored on the tangible memory), and at least one communication interface 41 (configured to communication with devices external to the data control device 30, such as actuator(s) 28), and an input/output device 42 (e.g., a touchscreen). The at least one processor 39 and at least one memory 40 may be in communication (e.g., wired and/or wirelessly) with one another. In one or some embodiments, the processor 39 may comprise a microprocessor, controller, PLA, or the like. Similarly, the memory 40 may comprise any type of storage device (e.g., any type of memory, such as RAM, ROM, or a combination thereof). Though the processor 49 and the memory 40 are depicted as separate elements, they may be part of a single machine, which includes a microprocessor (or other type of controller) and a memory. Alternatively, the processor 39 may rely on the memory 40 for all of its memory needs. Still alternatively, the processor 39 may rely on a database for some or all of its memory needs. The memory 40 may comprise a tangible computer-readable medium that include software that, when executed by the processor 39 is configured to perform any one, any combination, or all of the functionality described herein. Further, the communication interface 41 may be configured to communicate (e.g., wired and/or wirelessly) with one or more electronic devices, such as the actuator(s) 28. The input/output device 42 may be positioned in the driver's cab 37 and configured to: receive input from an operator in the driver's cab 37 (e.g., to control the process of the harvested material mat); and/or to output to the operator the results of the control (e.g., an indication of the harvested material mat).

The processor 39 and the memory 40 are merely one example of a computational configuration for the electronic devices discussed herein. Other types of computational configurations are contemplated. For example, all or parts of the implementations may be circuitry that includes a type of processor, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In this regard, the control device 30 may be configured to automatically actuate the actuators 28 depending on a harvested material throughput. In this case, the control device 30 may automatically control the actuators 28 in such a way that the wall element(s) 21 are pivoted further into the inner space of the grass chute 16 responsive to the control device 30 automatically determining that there is a low harvested material throughput and so that the wall element(s) 21 are not pivoted (or controlled) responsive to the control device 30 automatically determining that there is a high harvested material throughput. In other words, in one or some embodiments, the control device 30 may automatically actuate the actuators 28 in such a way that the wall elements 21 cause a greater taper of the grass chute 16 responsive to determining a low harvested material throughput than responsive to determining a high harvested material throughput. This may ensure that a harvested material mat fed to the post-acceleration device 12 has at least a predetermined thickness even with low throughputs. A thicker harvested material mat may be processed better by the post-acceleration device 12 so that a material stream ejected onto a transfer vehicle via the transfer device 13 may have an improved ejection quality.

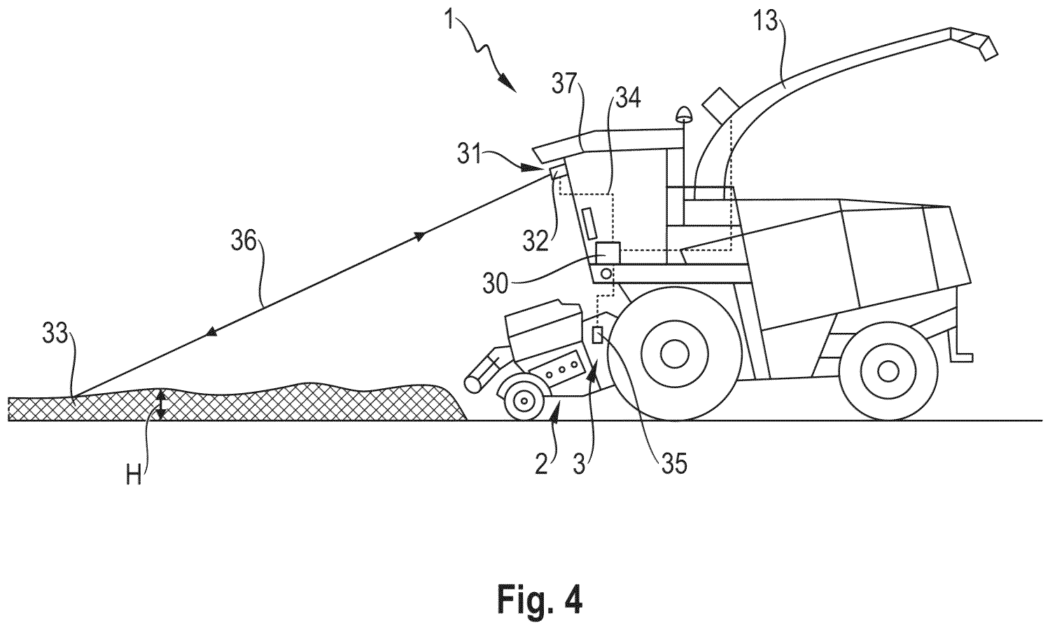

FIG. 4 illustrates a self-propelled forage harvester 1 with a swath detection device 31. The swath detection device 31 may be equipped with at least one optical sensor 32 configured to detect a forefield area (e.g., a section located in front of the harvester 1 in the direction of travel). The at least one optical sensor 32 may be configured to generate sensor data indicative of detecting the presence and/or a shape of a swath 33 in front of the harvester 1. The swath detection device 31 may transmit the sensor data determined or generated by the at least one optical sensor 32 to the control device 30 for automatic evaluation. For this purpose, the at least one optical sensor 32 may be in communication with the control device 30 (e.g., wired and/or wireless communication), such as via a bus system 34 so as to transmit signals. The at least one optical sensor 32 may comprise a camera (e.g., RGB camera, 3D camera) and/or LIDAR.

The at least one sensor 32, arranged or positioned on the driver's cab 37, may be configured to detect, using scanning beams 36, the presence of the swath 33 and/or its geometry and/or shape with which the swath 33 was deposited on the ground in a preceding process. As may be seen from the illustration in FIG. 4, the swath 33 may generally have an irregular height contour H. The height contour H may change along the swath 33 depending, among other things, on the harvested material density of the previously harvested material. The swath 33 may not only have an irregular height contour H, but may also vary to varying degrees in its width 32, which may also be detected by the at least one sensor 32.

In addition or alternatively, the swath detection device 31 may be designed with at least one sensor assembly 35, which may be configured to detect a layer height in the intake unit 3. Using the sensor assembly 35, the presence of harvested material and the throughput of harvested material may be determined.

In one or some embodiments, the control device 30 may be configured to automatically determine the harvested material throughput by analyzing the data determined by the swath detection device 31, such as the shape and/or the layer height H. Memory 40 of control device 30 may store a characteristic curve or a characteristic curve field for a position to be set for the wall elements 21 arranged or positioned in the grass chute 16 or harvested material conveyor chute 24 depending on the harvested material throughput. In turn, the control device 30 may automatically use the characteristic curve or the characteristic curve field in determining whether (and/or how) to actuate the actuators 28.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | |
|---|---|
| 1 | Self-propelled forage harvester |
| 2 | Front attachment |
| 3 | Intake unit |
| 4 | Feed roller |
| 5 | Feed roller |
| 6 | Chopping device |
| 7 | Cutterhead |
| 8 | Chopping blade |
| 9 | Shear bar |
| 10 | Feed channel |
| 11 | Post-processing device |
| 12 | Post-acceleration device |
| 13 | Transfer device |
| 14 | Rear wall |
| 15 | Front wall |
| 16 | Grass chute |
| 17 | Side wall |
| 18 | Outlet area |
| 19 | Connection area |
| 20 | Inlet area |
| 21 | Wall element |
| 22 | Housing |
| 23 | Conveyor rotor |
| 24 | Harvested material conveyor shaft |
| 25 | Hinge |
| 26 | End |
| 27 | End |
| 28 | Actuator |
| 29 | Pivot axis |
| 30 | Control device |
| 31 | Swath detection device |
| 32 | Sensor |
| 33 | Swath |
| 34 | Bus system |
| 35 | Sensor assembly |
| 36 | Scanning beam |
| 37 | Driver's cab |
| 38 | Joint |
| 39 | Processor |
| 40 | Memory |
| 41 | Communication interface |
| 42 | Input/output device |
| FR | Direction of material flow |
| H | Height contour |
| VF | Forward direction of travel |

1. A self-propelled forage harvester comprising:
a chopping device;
a post-acceleration device; and
a harvested material conveyor chute positioned between the chopping device and the post-acceleration device, wherein the harvested material conveyor chute includes an adjustable inner cross-section.

2. The self-propelled forage harvester of claim 1, wherein the harvested material conveyor chute has at least one position-adjustable wall element configured to adjust the inner cross-section.

3. The self-propelled forage harvester of claim 2, wherein the harvested material conveyor chute comprises a front wall, a rear wall and at least two side walls connecting the front wall and rear wall to one another; and
wherein the at least one position-adjustable wall element is positioned on at least one of the at least two side walls.

4. The self-propelled forage harvester of claim 3, wherein the at least two side walls comprise two mutually opposing side walls that connect the front wall and rear wall to one another.

5. The self-propelled forage harvester of claim 3, wherein the at least one position-adjustable wall element is positioned on both of the at least two side walls.

6. The self-propelled forage harvester of claim 2, wherein the at least one position-adjustable wall element extends, starting from an end of the harvested material conveyor chute facing the chopping device, to an end of the harvested material conveyor chute facing the post-acceleration device.

7. The self-propelled forage harvester of claim 2, wherein the at least one position-adjustable wall element is positioned pivotably on the harvested material conveyor chute using at least one joint.

8. The self-propelled forage harvester of claim 7, wherein the at least one joint comprises a hinge.

9. The self-propelled forage harvester of claim 7, the at least one joint is positioned at an end of the harvested material conveyor chute facing the chopping device.

10. The self-propelled forage harvester of claim 2, further comprising at least one actuator configured to adjust a position of the at least one position-adjustable wall element.

11. The self-propelled forage harvester of claim 1, further comprising a control device configured to:
automatically determine at least one aspect of harvested material; and
automatically control, based on the at least one aspect of the harvested material, adjustment of the inner cross-section of the harvested material conveyor chute.

12. The self-propelled forage harvester of claim 11, wherein the at least one aspect of the harvested material comprises harvested material throughput; and
wherein the control device is configured to automatically control the inner cross-section of the harvested material conveyor chute based on the harvested material throughput.

13. The self-propelled forage harvester of claim 12, wherein the harvested material conveyor chute has at least one position-adjustable wall element configured to adjust the inner cross-section;
further comprising at least one actuator configured to adjust a position of the at least one position-adjustable wall element; and
wherein the control device is configured to automatically control the inner cross-section of the harvested material conveyor chute by automatically controlling, based on the harvested material throughput, the actuator to automatically adjust the position of the at least one position-adjustable wall element.

14. The self-propelled forage harvester of claim 13, further comprising a swath detection device configured to generate data indicative of the at least one aspect of the harvested material; and
wherein the control device is further configured to automatically receive the data indicative of the at least one aspect of the harvested material; and
wherein the control device is configured to automatically determine the harvested material throughput by automatically evaluating the data generated by the swath detection device.

15. The self-propelled forage harvester of claim 14, wherein the swath detection device comprises at least one optical sensor configured to generate the data indicative of a shape of a swath to be collected by the forage harvester.

16. The self-propelled harvester of claim 15, wherein the swath detection device comprises at least one sensor array configured to detect an indication of a layer height in an intake unit of the forage harvester; and
wherein the swath detection device is configured to transmits the indication of the layer height to the control device; and
wherein the control device is configured to automatically determine, based on the indication of the layer height, the harvested material throughput.

17. The self-propelled forage harvester of claim 1, further comprising a feed channel;
wherein, viewed in a material flow direction of a harvested material flow, the feed channel is positioned downstream from the chopping device;
wherein the harvested material conveyor chute comprises a grass chute which adjoins the feed channel downstream; and
wherein the grass chute is positioned interchangeably on the feed channel.

18. A method for automatically controlling a self-propelled forage harvester, the forage harvester comprising a chopping device, a post-acceleration device and, a harvested material conveyor chute positioned between the chopping device and the post-acceleration device, the method comprising:
automatically determining at least one aspect of harvested material; and
automatically controlling, based on the at least one aspect of the harvested material, adjustment of an inner cross-section of the harvested material conveyor chute.

19. The method of claim 18, wherein the at least one aspect of the harvested material comprises harvested material throughput; and
wherein the inner cross-section of the harvested material conveyor chute is automatically controlled based on the harvested material throughput.

20. The method of claim 19, wherein the harvested material conveyor chute has at least one position-adjustable wall element configured to adjust the inner cross-section;
wherein the forage harvester further comprises at least one actuator configured to adjust a position of the at least one position-adjustable wall element; and
wherein the inner cross-section of the harvested material conveyor chute is automatically controlled by automatically controlling, based on the harvested material throughput, the actuator to automatically adjust the position of the at least one position-adjustable wall element.
